(19) United States
(12) Patent Application Publication
(10) Pub. No.: US 2024/0203632 A1
(43) Pub. Date: Jun. 20, 2024

(54) ELECTRONIC COMPONENT

(71) Applicant: DIAMOND&ZEBRA ELECTRIC MFG. CO., LTD., Osaka (JP)

(72) Inventor: Takashi IKEBE, Osaka (JP)

(73) Assignee: DIAMOND&ZEBRA ELECTRIC MFG. CO., LTD., Osaka (JP)

(21) Appl. No.: 18/515,640

(22) Filed: Nov. 21, 2023

(30) Foreign Application Priority Data
Dec. 20, 2022 (JP) 2022-203270

(51) Int. Cl. H01F 27/02; H01F 17/06

(52) U.S. Cl. CPC H01F 27/02; H01F 17/062

(57) ABSTRACT

An electronic component 2 includes a heat generator 4 and a case 6. The heat generator 4 includes a heat-generating element 24 located inside the case 6 and a top plate 14 located at least in part outside the case 6. The top plate 14 includes a positioner for fixing a position of the heat generator 4 relative to an electronic device. Preferably, the case 6 includes an opening at its upper surface, the top plate 14 includes a lid 18 covering the opening and a protrusion 20 extending from the lid 18 and projecting from the case 6 in plan view, and the positioner is a positioning hole 22 located in the protrusion 20.

### CROSS-REFERENCE TO RELATED APPLICATION

This application claims priority on and the benefit of Patent Application No. 2022-203270 filed in JAPAN on Dec. 20, 2022. The entire disclosures of this Japanese Patent Application are hereby incorporated by reference.

### BACKGROUND OF THE INVENTION

### Field of the Invention

The present specification discloses an electronic component.

### Description of the Related Art

Some electronic devices employ an electronic component such as a toroidal coil or transformer that generates a large amount of heat. Such a heat-generating electronic component often has a structure where a case made of a resin composition or metal contains therein a “heat generator” that actually generates heat. An example of the heat-generating electronic component is reported in Japanese Laid-Open Patent Application Publication No. 2011-210791.

When the case and the heat generator are combined in production of the electronic component, there may occur a positioning error between the case and the heat generator (a deviation from a given positional relationship between the case and the heat generator). In mounting of the electronic component into an electronic device, the case is fixed at a given location such as on a housing of the electronic device, and a terminal of the heat generator is connected to a given terminal of a circuit board of the electronic device. When the case is fixed to the electronic device, the terminal of the heat generator could be misaligned relative to the electronic device due to the positioning error between the case and the heat generator. This misalignment could make it difficult to incorporate the electronic component into the electronic device.

The present inventors aim to provide an electronic component that is easy to incorporate into an electronic device.

### SUMMARY OF THE INVENTION

An electronic component is mounted into an electronic device. The electronic component includes a heat generator and a case. The heat generator includes a heat-generating element located inside the case and a top plate located at least in part outside the case. The top plate includes a positioner for fixing a position of the heat generator relative to the electronic device.

In the electronic component, the heat generator includes the top plate located outside the case. The top plate includes the positioner for fixing the position of the heat generator relative to the electronic device. In the electronic component, the position of the heat generator relative to the electronic device can be fixed without being affected by a positioning error between the case and the heat generator. The electronic component is easy to incorporate into the electronic device.

### BRIEF DESCRIPTION OF THE DRAWINGS

FIG. 1 is a perspective view showing an electronic component according to one embodiment.

FIG. 2 is an exploded perspective view of the electronic component of FIG. 1.

FIG. 3 is a cross-sectional view of the electronic component of FIG. 1 taken along the line III-III.

FIG. 4 is a perspective view showing the electronic component of FIG. 1 which is being placed onto an electronic device.

FIG. 5 is a cross-sectional view showing the electronic component of FIG. 1 as incorporated in the electronic device.

FIG. 6 is a cross-sectional view that shows the electronic component of FIG. 1 as incorporated in the electronic device and that is taken at a different site than the cross-sectional view of FIG. 5.

FIG. 7 is a cross-sectional view showing an electronic component according to another embodiment.

### DESCRIPTION OF THE PREFERRED EMBODIMENTS

The following will describe in detail preferred embodiments with appropriate reference to the drawings.

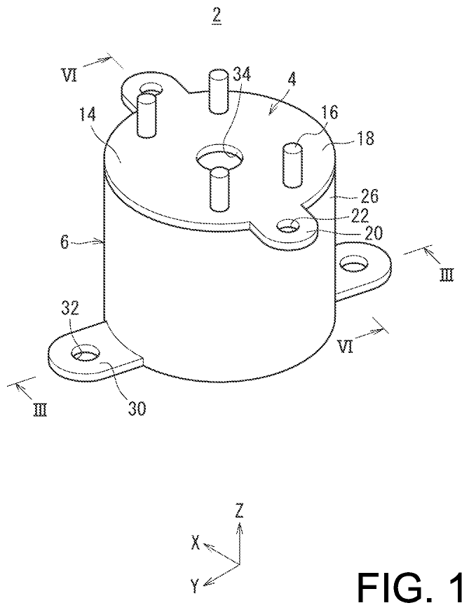

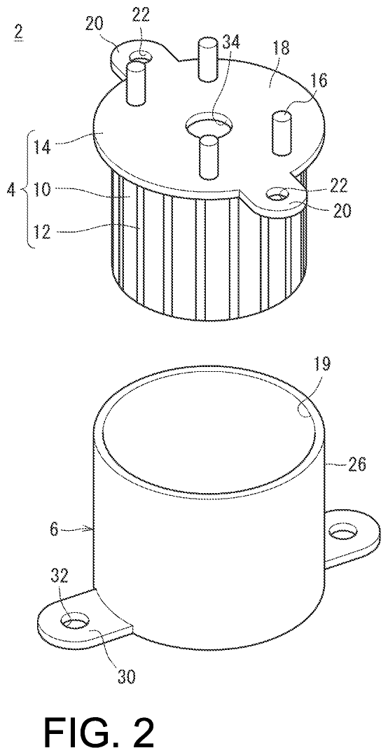

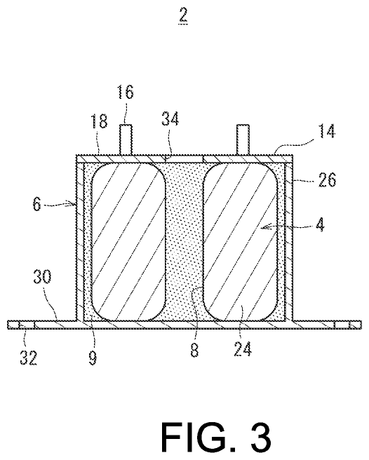

FIG. 1 is a perspective view showing an electronic component 2 according to one embodiment. In FIG. 1, the arrow X represents the forward direction with respect to the electronic component 2. The opposite direction is the backward direction. The arrow Y represents the rightward direction with respect to the electronic component 2. The opposite direction is the leftward direction. The arrow Z represents the upward direction with respect to the electronic component 2. The opposite direction is the downward direction. FIG. 2 is an exploded perspective view of the electronic component 2 of FIG. 1. FIG. 3 is a cross-sectional view taken along the line III-III of FIG. 1. As shown in FIGS. 1 and 2, the electronic component 2 includes a toroidal coil 4 and a case 6. As shown in FIG. 3, the electronic component 2 includes a filler 9 in a gap between the toroidal coil 4 and the case 6.

As shown in FIG. 2, the toroidal coil 4 includes a core 10, a wire 12, and a top plate 14. The core 10 is annular although the core 10 is not seen in its entirety in FIG. 2. That is, as shown in FIG. 3, the core 10 includes a central hole 8 extending through the core 10 in the up-down direction (the axial direction of the core 10). The core 10 is made of a magnetic material whose surface is covered with a resin composition. Preferred examples of the magnetic material include ferrite, dust, and silicon steel. The wire 12 is helically wound around the outer circumference of the core 10. The wire 12 is typically made of copper. In FIG. 3, the core 10 and the wire 12 are depicted in a simplified manner. In FIG. 3, the core 10 and the wire 12 are collectively depicted as one cross-section.

As shown in FIG. 1, the top plate 14 is located outside the case 6. In this embodiment, the entire top plate 14 is located outside the case 6. A part of the top plate 14 may be located inside the case 6. As shown in FIG. 2, the top plate 14 is placed on the upper surface of the core 10. The top plate 14 includes a lid 18, a protrusion 20, and a terminal 16. In this embodiment, the lid 18 is circular in plan view. The lid 18 need not be circular in plan view. The lid 18 may be elliptical or polygonal in plan view. The lid 18 covers an opening 19 of the case 6 described later. At the center of the lid 18 there is a hole 34.

The protrusion 20 extends outward from the lid 18 in the radial direction of the lid 18. In this embodiment, there are two protrusions 20. There may be only one protrusion 20 or three or more protrusions 20. Each of the protrusions 20 extends outward beyond the case 6 in the radial direction. In plan view, each of the protrusions 20 projects outside the case 6. Each of the protrusions 20 includes a positioning hole 22 extending through the protrusion 20 in the up-down direction. The lid 18 and the protrusions 20 are integrally formed. The lid 18 and the protrusions 20 may be separately formed.

The terminal 16 is located on the upper surface of the lid 18. There are a plurality of terminals 16 on the upper surface of the lid 18. The terminals 16 are electrically connected to the wire 12. Electricity is externally applied to the wire 12 through the terminals 16. Upon application of electricity to the wire 12 wound around the core 10, the toroidal coil 4 generates heat. The toroidal coil 4 is a heat generator 4. The portion of the heat generator 4 that actually generates heat is referred to as a heat-generating element. In this embodiment, the core 10 and the wire 12 constitute a heat-generating element 24.

The case 6 includes an internal space. The heat-generating element 24 is contained in the space. In this embodiment, the case 6 is in the shape of a cylindrical tube as shown in FIG. 2. The case 6 includes an opening 19 at its upper surface. The case 6 is electrically insulating. In this embodiment, the case 6 is made of a resin composition. Preferred examples of the material of the case 6 include PBT (polybutylene terephthalate), PPS (polyphenylene sulfide), and PET (polyethylene terephthalate). In the present specification, the statement that a material is “electrically insulating” means that the electrical conductivity of the material is 10⁻⁶ S/m or less. “S” denotes siemens which is the reciprocal of resistance “Ω (ohm)”, and “m” denotes distance (meter).

The case 6 includes a body 26 and a protrusion 30. The body 26 is tubular. The protrusion 30 is located at the lower end of the body 26. The protrusion 30 projects outward from the body 26 in the radial direction of the case 6. In this embodiment, there are two protrusions 30. There may be three or more protrusions 30. Each of the protrusions 30 includes an attachment hole 32. The body 26 and the protrusions 30 are integrally formed. The body 26 and the protrusions 30 may be separately formed.

The filler 9 fills the gap between the case 6 and the combination of the core 10 and the wire 12. The filler 9 fills the central hole 8 of the core 10. In the embodiment of FIG. 3, the filler 9 is located between the top plate 14 and the case 6. The filler 9 is electrically insulating. In this embodiment, the filler 9 is made of a thermosetting resin. A resin that cures at ordinary temperature may be used as the filler 9. Preferably, a resin having a high thermal conductivity is selected. The resin selected as the material of the filler 9 has low viscosity to completely fill the entire gaps within the case 6. Preferred examples of the filler 9 include epoxy resins.

In production of the electronic component 2, the case 6 and the toroidal coil 4 are prepared. The core 10 and wire 12 which constitute the heat-generating element 24 are inserted into the case 6, and the top plate 14 is placed onto the upper surface of the case 6. Thus, the heat-generating element 24 is contained in the case 6. The toroidal coil 4 is placed in a given position relative to the case 6. A liquid thermosetting resin is poured into the case 6 through the hole 34 of the lid 18 of the top plate 14. The thermosetting resin fills the gap between the case 6 and the toroidal coil 4. The thermosetting resin is heated and cured. Thus, the filler 9 is formed. In this manner, the electronic component 2 is obtained.

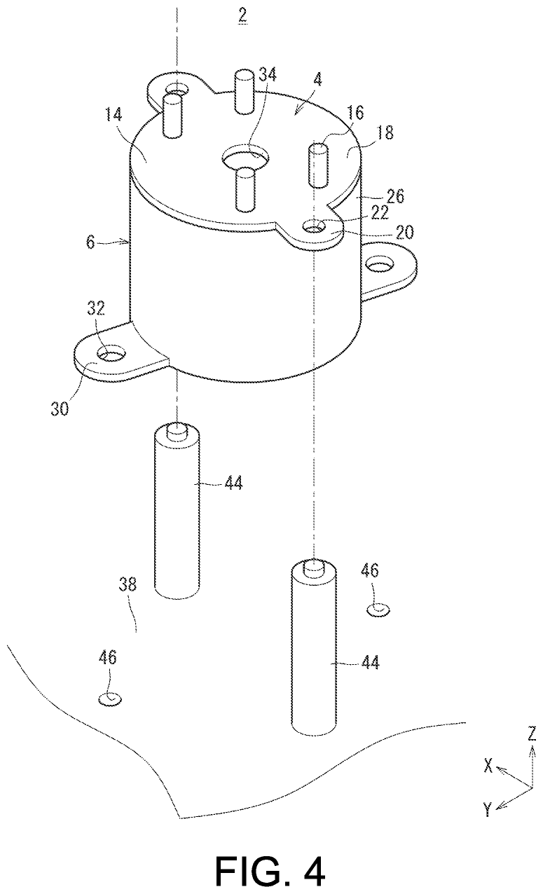

The electronic component 2 obtained is mounted into an electronic device. FIG. 4 shows the electronic component 2 which is being placed onto a housing 38 of the electronic device. In this embodiment, the housing 38 includes a pin 44 extending upward. The pin 44 is for positioning of the electronic component 2. In this embodiment, there are two pins 44. The housing 38 further includes a screw hole 46 for fixing the electronic component 2. In this embodiment, there are two screw holes 46. As shown in FIG. 4, when the electronic component 2 is placed on the housing 38, the tip of each of the pins 44 is inserted into the positioning hole 22 of a corresponding one of the protrusions 20.

A heat dissipator of the electronic device may include a pin, and the electronic component 2 is placed on the heat dissipator. Another component of the electronic device that exhibits a high heat dissipation effect may include a pin, and the electronic component 2 may be placed on the other component.

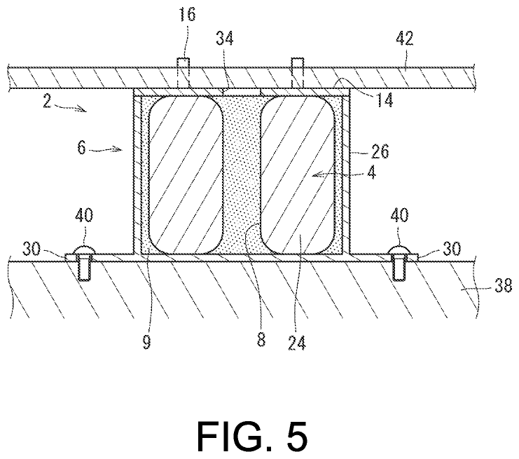

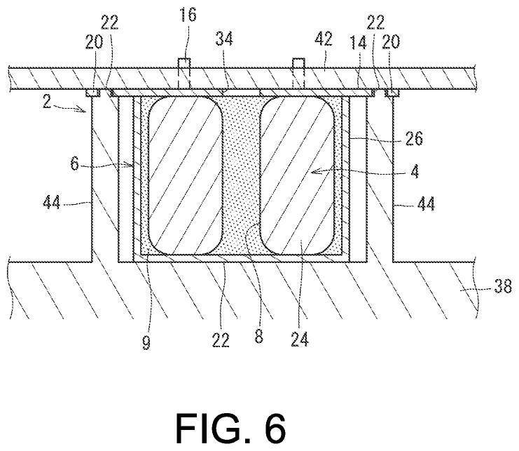

The electronic component 2 placed on the housing 38 is then fixed to the housing 38 by means of screws 40. Furthermore, the terminals 16 of the toroidal coil 4 are connected to terminals of a circuit board 42 of the electronic device. FIGS. 5 and 6 are cross-sectional views showing the electronic component 2 in this state.

The cross-section of the electronic component 2 which is shown in FIG. 5 is a cross-section taken along the line III-III of FIG. 1, just as is the cross-section of FIG. 3. The cross-section of FIG. 5 is one taken at a site where there are the protrusions 30 of the case 6. The electronic component 2 is placed such that the bottom surface of the case 6 is in contact with the housing 38. The screws 40 are inserted into the screw holes 46 of the housing 38 through the attachment holes 32. The screws 40 fix the electronic component 2 to the housing 38.

FIG. 6 is a cross-sectional view of the electronic device taken at a different site than the cross-sectional view of FIG. 5. The cross-section of the electronic component 2 which is shown in FIG. 6 is taken along the line VI-VI of FIG. 1. This cross-section is one taken at a site where there are the protrusions 20 of the top plate 14. As shown in FIG. 6, the tip of each of the pins 44 of the housing 38 is inserted into the positioning hole 22 of a corresponding one of the protrusions 20. This insertion fixes the positions of the terminals 16 of the toroidal coil 4 relative to the housing 38 of the electronic device. Thus, the positions of the terminals 16 of the toroidal coil 4 are fixed also relative to another component of the electronic device that is in a fixed position relative to the housing 38. For example, the positions of the terminals 16 of the toroidal coil 4 relative to the circuit board 42 of the electronic device are fixed. The positioning holes 22 of the protrusions 20 of the top plate 14 constitute a positioner that fixes the position of the toroidal coil 4 relative to the electronic device.

As shown in FIGS. 5 and 6, the circuit board 42 is located above the electronic component 2. The terminals 16 of the top plate 14 connect with given terminals of the circuit board 42. In this embodiment, the terminals of the circuit board 42 are embodied as through holes, and the terminals 16 of the toroidal coil 4 are inserted into the through holes. Thus, electricity can be applied from the circuit board 42 to the toroidal coil 4.

The following will describe the advantageous effects of the present embodiment.

In the electronic component 2 of the present embodiment, the heat generator 4 includes the top plate 14 located outside the case 6. The top plate 14 includes a positioner for fixing the position of the heat generator 4 relative to the electronic device. In this embodiment, the top plate 14 includes the positioning holes 22 as the positioner. For example, the position of the heat generator 4 relative to the electronic device can be fixed by placing the electronic component 2 in the electronic device such that the pins 44 of the electronic device pass through the positioning holes 22. In this embodiment, the positions of the terminal 16 of the toroidal coil 4 relative to the housing 38 are fixed, and thus the positions of the terminals 16 of the toroidal coil 4 relative to another component such as the circuit board 42 of the electronic device are also fixed. The position of the heat generator 4 is not affected by a positioning error between the case 6 and the heat generator 4. Thus, even if a positioning error occurs between the case 6 and the heat generator 4, a misalignment, for example, between the terminals 16 of the heat generator 4 and the terminals of the circuit board 42 can be prevented. This makes it easy to incorporate the electronic component 2 into the electronic device.

In this embodiment, the top plate 14 includes the protrusions 20 that project from the case 6 in plan view, and each of the protrusions 20 includes the positioning hole 22. Thus, the case 6 does not obstruct insertion of the pins 44 of the electronic device into the positioning holes 22 of the protrusions 20. This makes it easy to incorporate the electronic component 2 into the electronic device.

In terms of accurately positioning the heat generator 4 relative to the electronic device, the number of the protrusions 20 is preferably 2 or more. In terms of making it easy to place the heat generator 4 in the electronic device, the number of the protrusions 20 is preferably 4 or less.

In this embodiment, the case 6 includes the protrusions 30, and each of the protrusions 30 includes the attachment hole 32 for fixing the case 6 to the electronic device. The electronic component 2 can be firmly fixed to the electronic device by inserting the screws 40 into the screw holes 46 of the electronic device through the attachment holes 32.

In this embodiment, the inner diameter of the attachment holes 32 is greater than the nominal diameter of the screws 40. As previously stated, the position of the heat generator 4 relative to the electronic device is fixed by the positioning holes 22. A positioning error between the case 6 and the heat generator 4 could cause a misalignment between the centers of the attachment holes 32 of the case 6 and the centers of the screw holes 46 of the electronic device. Since the inner diameter of the attachment holes 32 is greater than the nominal diameter of the screws 40, the screws 40 can be inserted into the screw holes 46 of the electronic device through the attachment holes 32 of the case 6 even when there is a misalignment between the centers of the attachment holes 32 of the case 6 and the centers of the screw holes 46 of the electronic device. This makes it easy to incorporate the electronic component 2 into the electronic device. The outer diameter of the heads of the screws 40 is large enough so that the heads of the screws 40 cannot pass through the attachment holes 32. The heads of the screws 40 firmly fix the electronic component 2 to the electronic device.

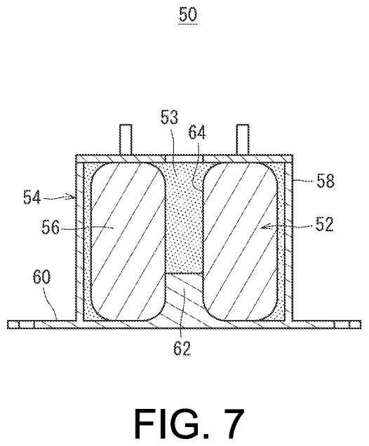

FIG. 7 is a cross-sectional view showing an electronic component 50 according to another embodiment. The electronic component 50 includes a toroidal coil 52 (heat generator 52) and a case 54. As shown in FIG. 7, the electronic component 50 includes a filler 53 in a gap between the heat generator 52 and the case 54. The heat generator 52 of the electronic component 50 is the same as the toroidal coil 4 of the electronic component 2 of FIG. 1.

As shown in FIG. 7, the case 54 includes an internal space. The case 54 contains a heat-generating element 56 (constituted by a core and a wire) of the heat generator 52 in the space. In this embodiment, the case 54 is in the shape of a cylindrical tube. The case 54 includes an opening at its upper surface. The case 54 is electrically insulating. In this embodiment, the case 54 is made of a resin composition. Preferred examples of the material of the case 54 include PBT, PPS, and PET.

The case 54 includes a body 58, protrusions 60, and a pillar 62. The body 58 is tubular. The protrusions 60 are located at the lower end of the body 58. The protrusions 60 project outward from the body 58 in the radial direction of the case 54. Each of the protrusions 60 includes an attachment hole. In this embodiment, the pillar 62 is located at the center of the bottom of the body 58. The pillar 62 extends upward from the bottom of the body 58. In the cross-section of FIG. 7, the pillar 62 is generally in the shape of a frustum. The pillar 62 is formed integrally with the body 58. The pillar 62 may be formed separately from the body 58.

As shown in FIG. 7, the pillar 62 is inserted into a central hole 64 of the heat-generating element 56 of the heat generator 52. The outer diameter of the upper end of the pillar 62 is substantially equal to the inner diameter of the hole 64 of the heat-generating element 56 (the inner diameter of the hole 64 as viewed from the bottom of the heat-generating element 56 including the wire wound around the core). The outer diameter of the upper end of the pillar 62 may be smaller than the inner diameter of the hole 64 of the heat-generating element 56. There may be a gap between the heat-generating element 56 and the pillar 62. In this case, the filler 53 is present in the gap between the heat-generating element 56 and the pillar 62.

In the electronic component 50 of the present embodiment, the case 54 includes the pillar 62 extending from the bottom surface of the case 54, and the pillar 62 is inserted into the hole 64 of the heat-generating element 56 constituted by the core and the wire. Thus, the position of the heat generator 52 relative to the case 54 can be prevented from deviating from a desired position. The positioning error between the heat generator 52 and the case 54 is reduced. This makes it easy to incorporate the electronic component 50 into an electronic device.

In the electronic component 50 of the present embodiment, the pillar 62 fills a part of the hole 64 of the heat-generating element 56, and thus the amount of the resin for forming the filler 53 is reduced. This contributes to cost reduction of the electronic component 50.

A resin composition having a higher thermal conductivity than the filler 53 may be used as the material of the pillar 62. The pillar 62 makes an effective contribution to dissipation of heat emitted from the heat-generating element 56. The electronic component 50 has excellent heat dissipation performance.

In the embodiments descried above, the protrusions of the top plate include holes serving as the positioner. The pins of an electronic device are inserted into the holes, and thus the position of the heat generator relative to the electronic device is fixed. The protrusions of the top plate may include pins serving as the positioner. The pins may be inserted into positioning holes of the electronic device to fix the position of the heat generator relative to the electronic device.

In the embodiments descried above, the toroidal coil is contained as a heat generator within the case. The heat generator is not limited to toroidal coils. The heat generator may be a reactor, transformer, or resistor. The heat generator may be any other element.

As described above, the electronic components are easy to incorporate into electronic devices. This demonstrates the superiority of the described embodiments.

### [Disclosed Items]

The following items are disclosures of preferred embodiments.

### [Item 1]

An electronic component to be mounted into an electronic device, the electronic component including:
a heat generator; and
a case, wherein
the heat generator includes a heat-generating element located inside the case and a top plate located at least in part outside the case, and
the top plate includes a positioner for fixing a position of the heat generator relative to the electronic device.

### [Item 2]

The electronic component according to item 1, wherein
the case includes an opening at an upper surface thereof,
the top plate includes a lid covering the opening and a protrusion extending from the lid, the protrusion projecting from the case in plan view, and
the positioner is a hole located in the protrusion.

### [Item 3]

The electronic component according to item 1 or 2, wherein the case includes an attachment hole for fixing the case to the electronic device.

### [Item 4]

The electronic component according to any one of items 1 to 3, wherein
the heat-generating element is annular and includes a central hole,
the case further includes a pillar extending upward from a bottom of the case, and
the pillar is inserted into the central hole of the heat-generating element.

### [Item 5]

The electronic component according to any one of items 1 to 4, wherein the heat-generating element includes a coil.

The electronic component as described above is applicable to various electronic devices.

The foregoing description is given for illustrative purposes, and various modifications can be made without departing from the principles of the present invention.

What is claimed is:

1. An electronic component to be mounted into an electronic device, the electronic component comprising:
a heat generator; and
a case, wherein
the heat generator includes a heat-generating element located inside the case and a top plate located at least in part outside the case, and
the top plate includes a positioner for fixing a position of the heat generator relative to the electronic device.

2. The electronic component according to claim 1, wherein
the case includes an opening at an upper surface thereof,
the top plate includes a lid covering the opening and a protrusion extending from the lid, the protrusion projecting from the case in plan view, and
the positioner is a hole located in the protrusion.

3. The electronic component according to claim 1, wherein the case includes an attachment hole for fixing the case to the electronic device.

4. The electronic component according to claim 1, wherein
the heat-generating element is annular and includes a central hole,
the case further includes a pillar extending upward from a bottom of the case, and
the pillar is inserted into the central hole of the heat-generating element.

5. The electronic component according to claim 1, wherein the heat-generating element includes a coil.
